(19) United States
(12) Patent Application Publication
(10) Pub. No.: US 2014/0278467 A1
(43) Pub. Date: Sep. 18, 2014

(54) HOME PATIENT HOSPITAL CARE COMMUNICATION BRIDGE SYSTEM AND METHOD

(71) Applicant: BRIDGEMED, INC., Pittsboro, NC (US)

(72) Inventors: Scott O. Spinka, Pittsboro, NC (US); James C. Saunders, Raleigh, NC (US)

(73) Assignee: BRIDGEMED, INC., Pittsboro, NC (US)

(21) Appl. No.: 13/837,789

(22) Filed: Mar. 15, 2013

(51) Int. Cl. G06F 19/00

(52) U.S. Cl. CPC G06F 19/3418
USPC 705/2

(57) ABSTRACT

The present invention is a data bridge system for coordinating digital data from multiple sources and delivering them on a single data server from a patient to a healthcare provider.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a home healthcare system. More particularly the present invention relates to a home healthcare data bridge system for coordinating home healthcare data from multiple sources to one or more healthcare providers.

2. Description of Related Art

The healthcare industry has long been concerned with taking care of patients who remain at home or other non-healthcare related locations. Those patients need frequent medical attention and measurement of their condition which has been usually maintained in the healthcare facility or by visits from a healthcare worker to the home to make the measurements.

More recently the advances in electronic devices have enabled a number of different means of connecting a patient in one location to the healthcare provider. While this is a tremendous advance there are hundreds of companies providing the systems requiring a myriad of connections at the patient and the healthcare provider locations to be able to monitor a patient and in fact typically the healthcare provider cannot monitor multiple systems at once. The healthcare provider tends to be overwhelmed by the multiple source data.

### BRIEF SUMMARY OF THE INVENTION

The present invention relates to the discovery that many of the above problems can be solved by having an internet based system wherein a single intermediate data server collects the multiple streams of digital medical data and gives the healthcare provider a single data feed of information thus making the home healthcare electronic experience more coordinated and function more precisely.

Accordingly in one embodiment there is a bridging system for coordinating a patient at a first location, having a plurality of digital data healthcare information devices in a home healthcare setting, with a healthcare provider at a separate location that will review the data comprising:
a) a patient interface device for routing the data from the plurality of digital data devices to a digital data transfer system;
b) a data transfer system;
c) a data center server connected to the data transfer system to receive the digital data from each the plurality of electronic data devices, the server capable of combining the data and delivering the combined digital data to the healthcare provider.

In another embodiment there is a method of delivering digital data from a plurality of digital data healthcare information devices in a patients home healthcare setting to a healthcare professional at a separate location comprising:
a) digitally connecting each of the digital devices to a patient interface device;
b) connecting the patient interface device to a data transfer system for delivering any digital data received from the digital devices;
c) the patient signing into the interface;
d) patient operating a plurality of the digital devices;
e) the patient interface receiving each of the digital information from each of the plurality digital devices and delivering it to a data center server using the data transfer system;
f) the data center server coordinating the plurality of data from a plurality of information devices into a single data stream and delivering the single data stream to the healthcare provider.

### BRIEF DESCRIPTION OF THE DRAWINGS

FIG. 1 is a relationship drawn of the parts of the bridge system.

FIG. 2 is a chart of the methods of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “patient” refers to a human or non-human subject who is being treated monitored or the like for a medical condition, disease or the like by a healthcare professional. The patient will be in a home healthcare setting. As used herein the term “home healthcare setting” refers to any first location where the healthcare professional monitoring the patient is not. In general that can be the home of the patient, a nursing home, vacation location, automobile, ambulance or the like where the patient is being monitored or in connection with multiple digital data devices.

As used herein, the term “healthcare provider” refers preferably to the patient's physician, most often their primary care physician, but may also refer to any employee, affiliate, colleague or agent of the physician or the healthcare provider's organization. For example, if the patient belongs to a health maintenance organization (HMO) the healthcare provider may refer to any employee of the HMO, such as doctors, specialists, nurses, administrators, pharmacy personnel, lab technicians, etc. It could be at the physician's office the hospital in general, the insurance company and could also include information services such as admissions, the IT department, billing records, health education and human resources; or Therapeutic services such as PT or OT, speech, language, respiratory therapy, pharmacy, nursing, dietary; diagnostic services such as the med lab, radiology, nuclear medicine, the emergency room, cardiology, neurology or the support services such as central supply, biomedical, housekeeping, maintenance, dietary and transportation. The healthcare provider is at a separate location that is not where the patient is located.

As used herein the term “patient interface device” is a hub for pubbing or connecting the plurality of digital data healthcare information devices into which can take each of the data streams for the devices and send them in a single stream while keeping the data individualized for later. The device hub will connect to a data transfer system to be able to send the single stream to the desired location a data center server.

As used herein the “data transfer system” is a system for transmitting digital information from one location to another. The internet, telephones and cell phones are practical examples but any system which moves the data is acceptable.

As used herein the term “digital data healthcare information device” refers to electronic devices used in the field of healthcare designed for monitoring one or more facets of a patient. The industry for so called remote healthcare devices is growing rapidly with many of the digital devices being wireless devices, or wired and including two way audio visual (a/v), respiratory, blood pressure, blood analysis, infusion control, ekg, temperature, fluid volume, cardio-diagnostics, blood and other chemistry assay protocol, blood glucose, vascular function, heart rate, lab on a chip implants and all digital physiological waveforms and measurements, also included are Doppler, thermal imaging, noncontact web assessments and the like. Digital signal may be of the type provided continuously, intermittently, as needed or at any desired fashion or interval, and the like.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc). The term is also intended to encompass non-public networks such as private (e.g., corporate) Intranets. As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

As used herein the term “data center server” refers to a computer system, including traditional desktop computers, as well as other computing devices (e.g., calculators, phones, watches, personal digital assistants, etc.). In some embodiments, the computer system comprises computer memory or a computer memory device and a computer processor. In some embodiments, the computer memory (or computer memory device) and computer processor are part of the same computer. In other embodiments, the computer memory device or computer memory is located on one computer and the computer processor is located on a different computer. In some embodiments, the computer memory is connected to the computer processor through the Internet or World Wide Web. In some embodiments, the computer memory is on a computer readable medium (e.g., floppy disk, hard disk, compact disk, DND, etc). In other embodiments, the computer memory (or computer memory device) and computer processor are connected via a local network or intranet. In some embodiments, “a processor” may in fact comprise multiple processors in communication with each other for carrying out the various processing tasks required to reach the desired end result. For example, the computer of an intermediary service provider may perform some processing or information storage and the computer of a customer linked to the intermediary service provider may perform other processing or information storage.

As used herein, the term “computer readable medium” refers to any device or system for storing and providing information (e.g., data and instructions) to a computer processor. Examples of computer readable media include, but are not limited to, DNDs, CDs, hard disk drives, magnetic tape and servers for streaming media over networks. As used herein, the term “encode” refers to the process of converting one type of information or signal into a different type of information or signal to, for example, facilitate the transmission and/or interpretability of the information or signal. For example, image files can be converted into (i.e., encoded into) electrical or digital information. Likewise, light patterns can be converted into electrical or digital information that provides an encoded video capture of the light patterns.

The data center server takes the digital signals received from the plurality of data devices and combines and delivers the data to the healthcare provider for use on single or multiple devices using a process stored on computer readable medium. As used herein, the term “in electronic communication” refers to electrical devices (e.g., computers, processors, etc.) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc) information to another computer or device, is in electronic communication with the other computer or device. As used herein, the term “transmitting” refers to the movement of information (e.g. data) from one location to another (e.g., from one device to another) using any suitable means.

The healthcare provider then after receipt can view utilized communication or the like not having to have a separate device for each device for each patient. A single device at the healthcare provider can then receive the digital data from the data center server and display all the desired information even though multiple different patients with multiple different devices are involved.

Now referring to the drawings, FIG. 1 is a relationship figure of the parts of the bridging system of the present invention. A patient in an in home setting, 1 has digital monitoring devices 2, or two way real time a/v device 3, or the like in communication between the patient 1 and an interface device 4. The interface device combines the digital signals from the monitoring device 2 and the a/v device 3 and is in communication with one or more of the internet 5 or the phone system (including cell phones) 6. The data center server 7 then sends the multiple streams to one or more healthcare providers such as insurance 8 the hospital/physician or anyone there 9 or some other 10 healthcare type provider.

In FIG. 2 there is a flow chart of the present invention. The home patient signs into the patient interface 21, then the interface establishes communication with the internet or phone digital connection to the data server 22. The patient then can initiate communication of the monitoring/communicating devices with the data server 23. The data server then combines all the data streams and delivers one stream to the healthcare provider at their location 24.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A bridging system for coordinating a patient at a first location, having a plurality of digital data healthcare information devices in a home healthcare setting, with a healthcare provider at a separate location that will review the data comprising:
a) a patient interface device for routing the data from the plurality of digital data devices to a digital data transfer system;
b) a data transfer system;
c) a data center server connected to the data transfer system to receive the digital data from each the plurality of electronic data devices, the server capable of combining the data and delivering the combined digital data to the healthcare provider.

2. The system for coordinating data according to claim 1 wherein the data transfer system is the internet.

3. The system for coordinating data according to claim 1 wherein the data transfer system is a phone system.

4. The system for coordinating data according to claim 1 wherein one of the pluralities of digital data healthcare information devices is a two way audio visual system between the patient and the healthcare professional.

5. A method of delivering digital data from a plurality of digital data healthcare information devices in a patients home healthcare setting to a healthcare professional at a separate location comprising:
a) digitally connecting each of the digital devices to a patient interface device;
b) connecting the patient interface device to a data transfer system for delivering any digital data received from the digital devices;
c) the patient signing into the interface;
d) patient operating a plurality of the digital devices;
e) the patient interface receiving each of the digital information from each of the plurality digital devices and delivering it to a data center server using the data transfer system;
f) the data center server coordinating the plurality of data from a plurality of information devices into a single data stream and delivering the single data stream to the healthcare provider.

6. The method according to claim 5 wherein the data transfer system is an internet.

7. The method according to claim 5 wherein the data transfer system is a telephone line.

8. The method according to claim 5 wherein one of the pluralities of digital data healthcare information devices is a two way audio visual system between the patient and the healthcare professional.
